(19) United States
(12) Patent Application Publication
(10) Pub. No.: US 2008/0082188 A1
(43) Pub. Date: Apr. 3, 2008

(54) Audio Player and Related Method Capable of Saving Memory Space

(76) Inventor: Wei-Chih Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/686,919

(22) Filed: Mar. 15, 2007

(30) Foreign Application Priority Data
Oct. 2, 2006 (TW) 095136570

(51) Int. Cl. G06F 17/00

(52) U.S. Cl. 700/94

(57) ABSTRACT

An audio player includes a logic block, an encoder, a first memory, and a decoder. The logic block has a first output end and a second output end. The logic block is used for determining whether to encode an audio signal or not, and outputting the audio signal at the first output end or the second output end correspondingly. The encoder has an input end for receiving the audio signal and is used for encoding the audio signal to generate an encoded data. The first memory has a first input end coupled to the encoder for storing the encoded data, and a second input end coupled to the second output end of the logic block for storing the audio signal. The decoder is coupled to the first memory and is used for decoding the encoded data or the audio signal in a corresponding manner to generate a decoded signal.

### BACKGROUND OF THE INVENTION

1. Field of the Invention

The present invention relates to an audio player, and more particularly, to an audio player for storing data after encoding to save memory space.

2. Description of the Prior Art

With the advent of digital music being readily available, users have a new source of musical content. Digital music content resides in relatively small digital files that can be stored on portable non-volatile memory devices. Due to the popularity of digital music, portable music players such as Moving Pictures Expert Group, Layer 3 (MP3) players, as well as other types of music players can be found everywhere. MP3 is an audio format that is well known and has made a clean sweep of the world recently. In addition, the price of MP3 player is cheap; so many products are equipped with it. Numerous audio standards are used nowadays. Besides the MP3 format there is the WMA format of Microsoft, the APE format of Monkey's Audio, and the RA format of Real Networks. These formats compete with the MP3 format, but their availability and their popularity could not compare with the MP3 format. The Internet has further added fuel to the flames to expand the availability and the popularity of the MP3 format.

An advantage of the MP3 format is that files have smaller data amount due to audio data already being compressed by utilizing specific algorithms to remove surplus portions from audio data. The tone quality of the MP3 music sounds close to the tone quality of the CD format. But the MP3 format belongs to a destructive compression and is unable to contend with the CD format no matter how high the sampling rates are. Another popular audio encoding manner is pulse code modulation (PCM). The PCM encoding has an advantage of having perfect tone quality, and a disadvantageous portion of having larger file size. A common audio CD adopts the PCM encoding and can only contain about 72 minutes of audio data. The WMA format is a format developed by Microsoft and professes that its tone quality is able to be close to the tone quality of the CD format under 64 kbps sampling rate. The APE format is provided by Monkey's Audio and belongs to a compression technology without destroying audio frequencies to make its tone quality not be damaged, and has a data amount being one half of the WAV format. Nevertheless, the APE format has an obsession with long compression/decompression time. In order to improve music transmitting efficiency under limited network bandwidths, the RA format is published by Real Networks to compete with other audio formats. Compression rates and error tolerances are stressed more than the tone quality due to the application of fully utilizing network bandwidth. Hence, the RA format becomes the most popular trial software on networks.

The demand for memory for storing audio and video data increases with the maturity and the prevalence of digital audio and video facilities. Among all categories, flash memory is one of the most popular memory types. Flash memory is a kind of non-volatile random access memory (NVRAM), and the data stored within can be changed rapidly.

MP3 applications are already disclosed in U.S. Pat. No. 7,010,218 “Digital magnetic Recording/Reproducing Device for Recording/Reproducing Plural Types of Audio Data, and Recording/Reproducing Method Therefore” and TW patent No. M286,961 “CD Player Capable of Converting to MP3”. A general digital magnetic recording/reproducing device usually utilizes a magnetic tape as a recording tool to store digital data such as image files or audio files. However, the magnetic tape is not used effectively. In U.S. Pat. No. 7,010,218, a digital magnetic recording/reproducing device and related method capable of recording or reproducing plural types of audio data are brought up. The method involves determining the data format of an audio signal first when receiving the audio signal. The audio signal is transformed into MP3 format and compressed into fixed size to be stored in a surplus block of the magnetic tape if the audio signal is a general audio signal and MP3 recording is selected. The audio signal is compressed into fixed size to be stored in the surplus block of the magnetic tape if the audio signal is the MP3 format. Therefore, memory space of the magnetic tape is fully utilized.

In the TW patent No. M286,961, the method involves utilizing a digital signal processor to transform a digital audio-track data read from a disc of a CD-ROM drive into an MP3 format data and storing it in memory cards or in external USB devices through a USB bus. Please refer to FIG. 1. FIG. 1 is a block diagram of a CD player 10 provided with MP3 transformation function in the prior art. The CD player 10 reads a digital audio-track data (a general audio format data) of a disc 11 through a CD-ROM drive 12 and transmits the digital audio-track data to an IDE interface control circuit 14 through an IDE interface 13. A memory 15 is coupled to the IDE interface control circuit 14 for receiving and storing the digital audio-track data from the IDE interface control circuit 14. A digital signal processor 17 not only is used for dealing with data, but also controls the CD player 10. A major job of the digital signal processor 17 is reading the digital audio-track data from the memory 15 and transforming the digital audio-track data into the MP3 format data. A USB device 19 is coupled to the digital signal processor 17 for receiving the MP3 format data transformed by the digital signal processor 17. The MP3 format data outputted from the digital signal processor 17 is transmitted to a memory card 18. The memory card 18 can be a CF card, a SD card, a MMC card, a SM card, or a XD card.

Audio data stored in CD discs is digital data that is not compressed yet and has better tone quality. Its drawback is that data amount is large. In U.S. Pat. No. 7,010,218, storage utility rate is improved but only limited to magnetic tape. As shown in FIG. 1, large memory space is necessary due to data format stored in the memory 15 being a general digital audio-track data and not being compressed. Audio players capable of playing the CD format and the MP3 format at the same time can be found in market conditions today. A large SDRAM is necessary which causes expensive cost and large IC area due to data in the CD format and in the MP3 format being stored directly.

### SUMMARY OF THE INVENTION

The claimed invention provides an audio player capable of saving memory space. The audio player includes a logic block, an encoder, a first memory, and a decoder. The logic block has a first output end and a second output end. The logic block is used for receiving an audio signal, determining whether to encode the audio signal or not, and outputting the audio signal at the first output end or the second output end correspondingly. The encoder has an input end coupled to the first output end of the logic block for receiving the audio signal. The encoder is used for encoding the audio signal to generate an encoded data. The first memory has a first input end coupled to the encoder for storing the encoded data, and a second input end coupled to the second output end of the logic block for storing the audio signal. The decoder is coupled to the first memory. The decoder is used for receiving the encoded data or the audio signal stored in the first memory, and decoding the encoded data or the audio signal in a corresponding manner to generate a decoded signal. The encoder encodes the audio signal according to a first encoding manner, and the decoder decodes the encoded data to generate the decoded signal according to the first encoding manner. The audio signal is a signal encoded according to a second encoding manner, and the decoder decodes the audio signal to generate the decoded signal according to the second encoding manner. The encoder is an MP3 encoder, and the decoder is an MP3 decoder. The encoder is an ADPCM encoder, and the decoder is an ADPCM decoder.

The claimed invention provides an audio playing method capable of saving memory space. The method includes determining whether to encode an audio signal according to a data format of the audio signal or not, encoding the audio signal according to a first encoding manner to generate an encoded data when the data format of the audio signal is general audio-track data, storing the encoded data or the audio signal, and decoding the encoded data or the audio signal in corresponding manner to generate a decoded signal. When the audio signal is a signal encoded according to the first encoding manner, the audio signal is decoded to generate the decoded signal according to the first encoding manner. When the audio signal is a signal encoded according to a second encoding manner, the audio signal is decoded to generate the decoded signal according to the second encoding manner. The method further includes transforming the decoded signal into a playing signal in an analog format and further playing the playing signal in the analog format. In an embodiment of the present invention, the first encoding manner and the second encoding manner are encoding manners in an MP3 format or an ADPCM format individually. If the audio signal is encoded according to the encoding manner in the MP3 format to generate the encoded data in the MP3 format, then the encoded data in the MP3 format is decoded to generate a decoded signal according to the encoding manner in the MP3 format. If the audio signal is encoded according to the encoding manner in the ADPCM format to generate the encoded data in the ADPCM format, then the encoded data in the ADPCM format is decoded to generate a decoded signal according to the encoding manner in the ADPCM format.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a CD player provided with MP3 transformation function in the prior art.

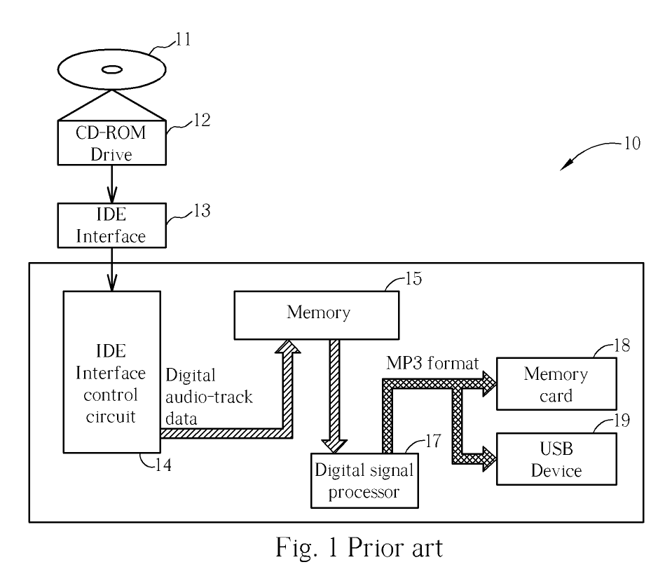

FIG. 2 is a diagram illustrating an audio player capable of saving memory space according to an embodiment of the present invention.

FIG. 3 is a diagram illustrating an audio player capable of saving memory space according to another embodiment of the present invention.

FIG. 4 is a diagram illustrating a flow of an audio playing method capable of saving memory space according to an embodiment of the present invention.

### DETAILED DESCRIPTION

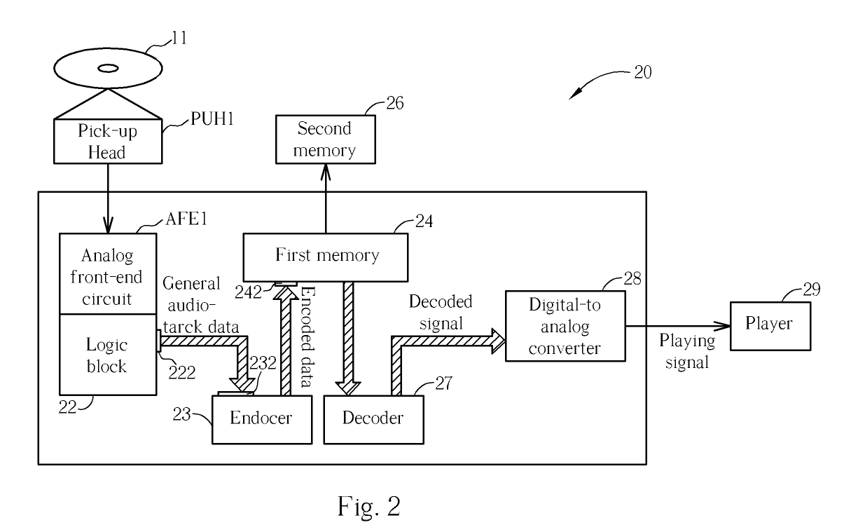

Please refer to FIG. 2, which is a diagram illustrating an audio player 20 capable of saving memory space according to an embodiment of the present invention. FIG. 2 denotes a storage path of a general audio-track data. The audio player 20 includes a CD disc 11, a pick-up head PUH1, an analog front end circuit AFE1, a logic block 22, an encoder 23, a first memory 24, a second memory 26, a decoder 27, a digital-to-analog converter 28, and a player 29. The pick-up head PUH1 is used for reading data of the CD disc 11. The analog front end circuit AFE1 is coupled to the pick-up head PUH1 and the logic block 22. The analog front end circuit AFE1 is used for transforming received data into an audio signal in a digital format and transmitting the audio signal in the digital format to the logic block 22. The logic block 22 is coupled to the analog front end circuit AFE1. The logic block 22 has a first output end 222 and a second output end (not shown in FIG. 2). The logic block 22 is used for receiving the audio signal, determining whether to encode the audio signal or not, and outputting the audio signal at the first output end 222 or the second output end (not shown in FIG. 2) correspondingly. Data must be encoded by the encoder 23 if the received data is the general audio-track data. The encoder 23 has an input end 232 coupled to the first output end 222 of the logic block 22 for receiving the audio signal that is the general audio-track data. The encoder 23 is used for encoding the audio signal to generate an encoded data. The first memory 24 has a first input end 242 coupled to the encoder 23 for storing the encoded data. The second memory 26 is coupled to the first memory 24 for storing data transmitted from the first memory 24. The first memory 24 is a buffer, and the second memory 26 is a synchronous dynamic random access memory (SDRAM). The decoder 27 is coupled to the first memory 24 and is used for decoding the data transmitted from the first memory 24 correspondingly to generate a decoded signal (decoding the encoded data correspondingly in this embodiment). The digital-to-analog converter 28 is coupled to the decoder 27. The digital-to-analog converter 28 is used for transforming the decoded signal decoded by the decoder 27 into a playing signal in an analog format. The player 29 is coupled to the digital-to-analog converter 28 for playing the playing signal in the analog format. The encoder 23 encodes the audio signal according to a first encoding manner, and the decoder 27 decodes the encoded data according to the first encoding manner. For example, the encoder can be an MP3 encoder, an ADPCM encoder or encoders in other types. The decoder 27 must adopt decoders corresponding to the encoder 23. For instance, the encoder 23 is an MP3 encoder, and the decoder 27 is an MP3 decoder so that the encoded data or the audio signal can be decoded correctly.

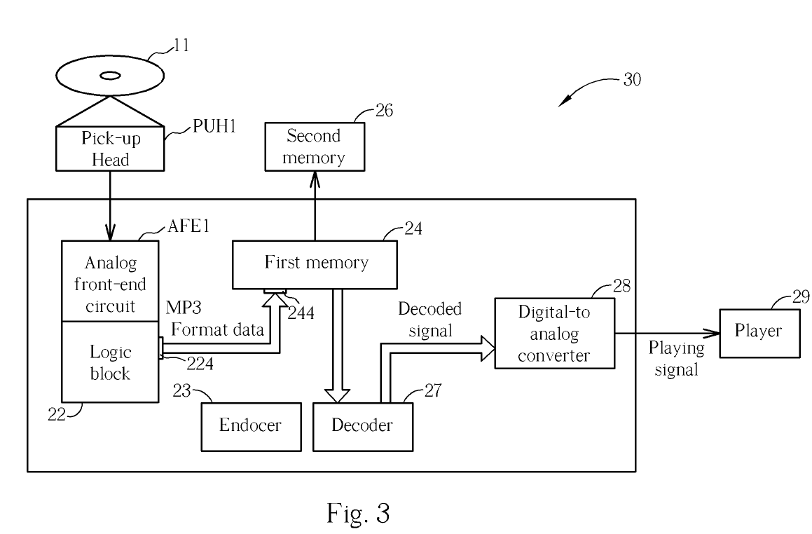

Please refer to FIG. 3, which is a diagram illustrating an audio player 30 capable of saving memory space according to another embodiment of the present invention. FIG. 3 denotes a storage path of an MP3 format data. The audio player 30 includes a CD disc 11, a pick-up head PUH1, an analog front end circuit AFE1, a logic block 22, an encoder 23, a first memory 24, a second memory 26, a decoder 27, a digital-to-analog converter 28, and a player 29. The pick-up head PUH1 is used for reading data of the CD disc 11. The analog front end circuit AFE1 is coupled to the pick-up head PUH1 and the logic block 22. The analog front end circuit AFE1 is used for transforming received data into an audio signal in a digital format and transmitting the audio signal in the digital format to the logic block 22. The logic block 22 is coupled to the analog front end circuit AFE1. The logic block 22 has a first output end (not shown in FIG. 3) and a second output end 224. The logic block 22 is used for receiving the audio signal, determining whether to encode the audio signal or not, and outputting the audio signal at the first output end (not shown in FIG. 3) or the second output end 224 correspondingly. Data will not be encoded by the encoder 23 if the received data is the MP3 format data (or compressed data). The first memory 24 has a second input end 244 coupled to the second output end 224 of the logic block 22 for storing the audio signal in the MP3 format. The second memory 26 is coupled to the first memory 24 for storing data transmitted from the first memory 24. The first memory 24 is a buffer, and the second memory 26 is a synchronous dynamic random access memory (SDRAM). The decoder 27 is coupled to the first memory 24 and is used for decoding the data transmitted from the first memory 24 correspondingly to generate a decoded signal (decoding the audio signal in the MP3 format correspondingly in this embodiment). The digital-to-analog converter 28 is coupled to the decoder 27. The digital-to-analog converter 28 is used for transforming the decoded signal decoded by the decoder 27 into a playing signal in an analog format. The player 29 is coupled to the digital-to-analog converter 28 for playing the playing signal in the analog format. If the audio signal is encoded according to a second encoding manner (such as the MP3 decoding manner), and the decoder 27 decodes the encoded data according to the first encoding manner. For example, if the audio signal is the MP3 format data, the decoder 27 must be an MP3 decoder. If the audio signal is a WMA format data, the decoder 27 must be a WMA decoder.

Please keep referring to FIG. 2 and FIG. 3. As shown in FIG. 2, the audio signal is the general audio-track data that has better tone quality but large data amount due to not being compressed. For this reason, the audio signal needs to be encoded by the encoder 23 first to generate the encoded data having smaller data amount. The data amount of the encoded data is much smaller than the audio signal and will get different results depends on different algorithms of the encoder 23. Then the encoded data is stored in the first memory 24 and only occupies a small portion of the first memory 24. As shown in FIG. 3, the audio signal is the MP3 format data (or compressed data) and has small data amount that does not need to be encoded by the encoder 23. The audio signal is stored directly in the first memory 24 and only occupies a small memory space. The second memory 26 is used for storing data transmitted from the first memory 24. A memory size of the second memory 26 can be reduced due to data stored in the first memory 24 being smaller. For example, the memory size of the second memory 26 can be reduced to one-fifth of the original memory size when the data amount of the encoded data is compressed to 20% of the data amount of the audio signal. The present invention can provide aseismatic design for 50 seconds to make audio players have better aseismatic effect if the memory size of the second memory 26 keeps the same and can provide aseismatic design for 10 seconds originally.

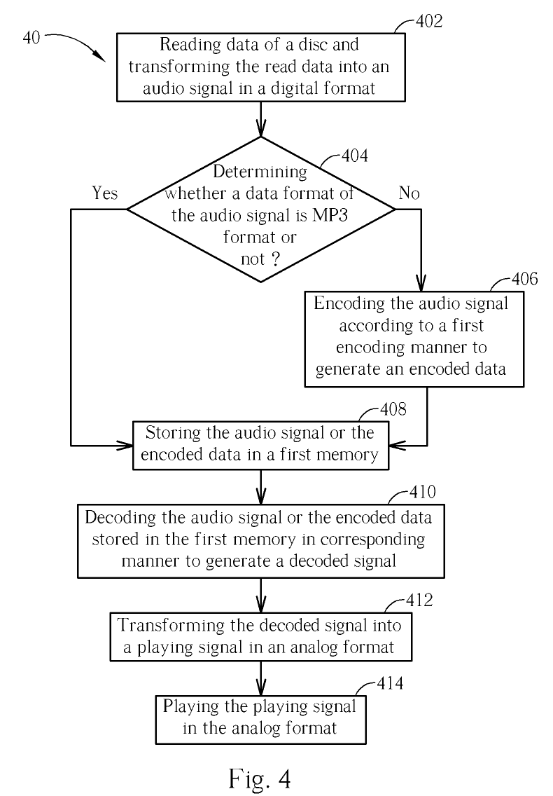

Please refer to FIG. 4. FIG. 4 is a diagram illustrating a flow 40 of an audio playing method capable of saving memory space according to an embodiment of the present invention. The flow 40 includes the following steps:

Step 402: Reading data of a disc and transforming the read data into an audio signal in a digital format.

Step 404: Determining whether a data format of the audio signal is MP3 format or not.

Step 406: Encoding the audio signal according to a first encoding manner to generate an encoded data if the data format of the audio signal is not MP3 format.

Step 408: Storing the audio signal or the encoded data in a first memory.

Step 410: Decoding the audio signal or the encoded data stored in the first memory in corresponding manner to generate a decoded signal.

Step 412: Transforming the decoded signal into a playing signal in an analog format.

Step 414: Playing the playing signal in the analog format.

In step 404, the data format of the audio signal is determined whether it is MP3 format (or other compressed format) first. The process proceeds to step 408 and the audio signal is stored in the first memory directly if the data format of the audio signal is MP3 format. The process then proceeds to step 406 and the audio signal is encoded to generate an encoded data if the data format of the audio signal is the general audio-track data. Next, the process proceeds to step 408 and the encoded data is stored in the first memory. In step 410, the audio signal or the encoded data stored in the first memory is decoded in corresponding manner to generate the decoded signal. Finally, the decoded signal is transformed into the playing signal in the analog format and further the playing signal in the analog format is played.

The abovementioned embodiments are presented merely for describing the present invention, and in no way should be considered to be limitations of the scope of the present invention. The mentioned encoder 23 is not limited to an MP3 encoder merely, and can be encoders of other types. Similarly, the decoder 27 is not limited to an MP3 decoder merely, but should correspond to the type of the encoder 23. The first memory 24 is not limited to a buffer and the second memory 26 is not limited to a SDRAM only, and other elements may also be utilized for implementing the abovementioned memory. The claimed invention is applied to audio paths with both the CD format and the MP3 format at the same time.

From the above descriptions, the present invention provides the audio players 20 and 30 capable of saving memory space. An objective of the present invention is that a non-encoded audio signal is compressed by the encoder 23 and is stored in the second memory to save memory space and reduce chip areas. Through this way, problems of wasting too much chip areas can be solved and quality of products can be improved by utilizing the audio player of the present invention. Furthermore, the audio player of the present invention is applied to audio paths with both the CD format and the MP3 format at the same time that can provide widespread applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio player capable of saving memory space comprising:
a logic block having a first output end and a second output end, the logic block used for receiving an audio signal, determining whether to encode the audio signal or not, and outputting the audio signal at the first output end or the second output end correspondingly;
an encoder having an input end coupled to the first output end of the logic block for receiving the audio signal, the encoder used for encoding the audio signal to generate an encoded data;
a first memory having a first input end coupled to the encoder for storing the encoded data, and a second input end coupled to the second output end of the logic block for storing the audio signal; and
a decoder coupled to the first memory, the decoder used for receiving the encoded data or the audio signal stored in the first memory, and decoding the encoded data or the audio signal in a corresponding manner to generate a decoded signal.

2. The audio player of claim 1 wherein the encoder encodes the audio signal according to a first encoding manner, and the decoder decodes the encoded data to generate the decoded signal according to the first encoding manner.

3. The audio player of claim 1 wherein the audio signal is a signal encoded according to a second encoding manner, and the decoder decodes the audio signal to generate the decoded signal according to the second encoding manner.

4. The audio player of claim 1 further comprising:
a pick-up head used for reading data of a disc; and
an analog front end circuit coupled to the pick-up head and the logic block, the analog front end used for transforming received data into the audio signal in a digital format and transmitting the audio signal to the logic block.

5. The audio player of claim 1 wherein the first memory is a buffer.

6. The audio player of claim 1 further comprising a second memory coupled to the first memory, the second memory used for storing data.

7. The audio player of claim 6 wherein the second memory is a synchronous dynamic random access memory (SDRAM).

8. The audio player of claim 1 further comprising:
a digital-to-analog converter coupled to the decoder for transforming the decoded data into a playing signal in an analog format; and
a player coupled to the digital-to-analog converter for playing the playing signal in the analog format.

9. The audio player of claim 1 wherein the audio player is a CD-MP3 player used for playing data in a CD format and in an MP3 format.

10. The audio player of claim 2 wherein the encoder is an MP3 (Moving Picture Experts Group 1 Layer-3) encoder, and the decoder is an MP3 decoder.

11. The audio player of claim 2 wherein the encoder is an adaptive differential pulse code modulation (ADPCM) encoder and the decoder is an ADPCM decoder.

12. An audio playing method capable of saving memory space comprising:
(a) determining whether to encode an audio signal according to a data format of the audio signal or not;
(b) encoding the audio signal according to a first encoding manner to generate an encoded data when the data format of the audio signal is general audio-track data;
(c) storing the encoded data or the audio signal; and
(d) decoding the encoded data or the audio signal in corresponding manner to generate a decoded signal.

13. The audio playing method of claim 12 wherein step (d) is decoding the encoded data to generate the decoded signal according to the first encoding manner.

14. The audio playing method of claim 12 wherein in step (a) the audio signal is a signal encoded according to a second encoding manner, and step (d) is decoding the audio signal to generate the decoded signal according to the second encoding manner.

15. The audio playing method of claim 14 wherein the first encoding manner and the second encoding manner are encoding manners in an MP3 format.

16. The audio playing method of claim 15 wherein step (b) is encoding the audio signal according to the encoding manner in the MP3 format to generate the encoded data in the MP3 format, and step (d) is decoding the encoded data in the MP3 format to generate a decoded signal according to the encoding manner in the MP3 format.

17. The audio playing method of claim 14 wherein the first encoding manner and the second encoding manner are encoding manners in an ADPCM format.

18. The audio playing method of claim 17 wherein step (b) is encoding the audio signal according to the encoding manner in the ADPCM format to generate the encoded data in the ADPCM format, and step (d) is decoding the encoded data in the ADPCM format to generate a decoded signal according to the encoding manner in the ADPCM format.

19. The audio playing method of claim 12 further comprising:
transforming the decoded signal into a playing signal in an analog format and further playing the playing signal in the analog format.

20. The audio playing method of claim 12 further comprising: reading data of a disc and transforming the read data into the audio signal in a digital format.
